(19) United States
(12) Patent Application Publication
(10) Pub. No.: US 2023/0138311 A1
(43) Pub. Date: May 4, 2023

(54) HEAT EXCHANGER AND METHOD THEREOF PROCESSING THE SAME

(71) Applicant: Hangzhou Sanhua Research Institute Co., Ltd., Hangzhou (CN)

(72) Inventors: Hai HUANG, Hangzhou (CN); Jianhua TANG, Hangzhou (CN); Shurui YU, Hangzhou (CN); Ming XUE, Hangzhou (CN); Linjie HUANG, Hangzhou (CN)

(21) Appl. No.: 17/980,436

(22) Filed: Nov. 3, 2022

(30) Foreign Application Priority Data
Nov. 4, 2021 (CN) 202111296740.0

(51) Int. Cl. F28F 1/10; F28F 19/02; C09D 183/08; C09D 5/02; C23C 22/48; C09D 7/20; C09D 7/61; C09D 7/40

(52) U.S. Cl. CPC F28F 1/10; F28F 19/02; C09D 183/08; C09D 5/028; C23C 22/48; C09D 7/20; C09D 7/61; C09D 7/66; F28F 2245/04

(57) ABSTRACT

A heat exchanger and a processing method of heat exchanger. The heat exchanger includes a collecting pipe, a fin and a number of heat exchange tubes. The heat exchange tubes are fixed with the collecting pipe. At least part of the fin is fixed between two adjacent heat exchange tubes. The heat exchanger includes a coating with a first matching coating which is in direct contact with at least one of the collecting pipe, the heat exchange tubes and the fin; or, at least one functional films is further spaced between the first matching coating and at least one of the collecting pipe, the heat exchange tubes and the fin. The first matching coating includes a hydrophobic material and a filler of nanoparticle type.

### CROSS-REFERENCE TO RELATED APPLICATIONS

The present application claims priority to Chinese Patent Application No. 202111296740.0, filed on Nov. 4, 2021, the content of which is incorporated herein by reference in its entirety.

### TECHNICAL FIELD

The present disclosure relates to the technical field of heat exchange devices and in particular to a heat exchanger and a processing method of the heat exchanger.

### BACKGROUND

In some related art, a hydrophobic coating material is prepared by modifying silicon dioxide particles by sol-gel method. By coating the hydrophobic coating material on the surface of microchannel heat exchanger, it is conducive to forming a hydrophobic coating of the sol-gel system. The above-mentioned coating makes it difficult for droplets to stay on the surface of the heat exchanger through the hydrophobicity thereof, so that the heat exchanger has certain corrosion resistance.

However, micropores or pores exist in the molecular network structure of the sol-gel coating, and is thereby prone to become paths for the corrosive medium to diffuse to the metal substrate. Therefore, it is still difficult for the sol-gel coating in the related art to achieve a more ideal corrosion resistance effect, and the related art needs improvement.

### SUMMARY

The purpose of the present disclosure is to provide a heat exchanger with better corrosion resistance. Correspondingly, the present disclosure also provides a processing method of the heat exchanger, which is conducive to generating relatively excellent corrosion resistance on the heat exchanger.

In the first aspect, the present disclosure provides a heat exchanger. The heat exchanger includes a collecting pipe, a fin and heat exchange tubes. The heat exchange tubes are fixed to the collecting pipe, and inner cavities of the heat exchange tubes are communicated with an inner cavity of the collecting pipe. At least part of the fin is fixed between two adjacent heat exchange tubes.

The heat exchanger further includes a coating. The coating is coated on at least part of an outer surface of at least one of the collecting pipe, the heat exchange tubes and the fin. The coating includes a first matching coating. The first matching coating is in direct contact with at least one of the collecting pipe, the heat exchange tubes and the fin; or, at least one further functional film is further spaced between the first matching coating and at least one of the collecting pipe, the heat exchange tubes and the fin.

The first matching coating includes a hydrophobic material and a filler of nanoparticle type, and a weight per unit area of the first matching coating is in a range of 0.1 g/m²˜1 g/m².

For the heat exchanger of the present disclosure, since the first matching coating includes the hydrophobic material and the filler of nanoparticle type, the hydrophobic material itself is conducive to making it difficult for the corrosive medium to stay on the outer surface of each component of the heat exchanger, the filler of nanoparticle type is conducive to being filled into the molecular network structure of the hydrophobic material, and the weight per unit area of the first matching coating is controlled within a reasonable range of 0.1 g/m²˜1 g/m², so that film compactness, hardness and other properties of the first matching coating can reach an ideal range. Correspondingly, it is also conducive to improving the barrier performance of the first matching coating to the corrosive medium, and to prolonging the duration for the corrosive medium to reach the metal substrate of each component of the heat exchanger to some certain extent. Finally, the heat exchanger achieves relatively excellent corrosion resistance.

In the second aspect, the present disclosure provides a processing method of the heat exchanger, including the following steps:

Providing a composite material and a heat exchanger. The composite material includes a hydrophobic material and a filler of nanoparticle type; the heat exchanger includes a collecting pipe, a fin and heat exchange tubes; the heat exchange tubes are fixed to the collecting pipe, and inner cavities of the heat exchange tubes are communicated with an inner cavity of the collecting pipe; at least part of the fin is fixed between two adjacent heat exchange tubes; and at least part of an outer surface of at least one of the collecting pipe, the fin and the heat exchange tubes is exposed or coated with at least one further functional film.

Coating the composite material on at least part of the outer surface of at least one of the collecting pipe, the fin and the heat exchange tubes, or coating the composite material on the outer surface of the further functional film, and forming a first matching coating after curing.

For the processing method of the heat exchanger, since the composite material includes the hydrophobic material and the filler of nanoparticle type, after the surface of the heat exchanger is treated, the hydrophobic material itself is conducive to making it difficult for the corrosive medium to stay on the outer surface of each component of the heat exchanger, and the filler of nanoparticle type is conducive to being filled into the molecular network structure of the hydrophobic material, so that film compactness, hardness and other properties of the first matching coating. Correspondingly, it is also conducive to improving the barrier performance of the first matching coating to the corrosive medium and to prolonging the time for the corrosive medium to reach the metal substrate of each component of the heat exchanger to some certain extent. Finally, the heat exchanger achieves relatively excellent batter corrosion resistance.

### BRIEF DESCRIPTION OF DRAWINGS

FIG. 1 is a structural schematic diagram of a heat exchanger according to an embodiment of the present disclosure;

FIG. 2 is an enlarged schematic diagram of the assembly structure of part of components of the heat exchanger shown in FIG. 1;

FIG. 3 is a schematic diagram showing the combination of a coating and a metal substrate corresponding to a fin according to an embodiment of the present disclosure;

FIG. 4 is a schematic flowchart of a processing method of a heat exchanger according to an embodiment of the present disclosure;

FIG. 5 is a schematic flowchart of a method for preparing a composite material according to an embodiment of the present disclosure;

FIG. 6 is a schematic diagram showing the combination of a coating and a metal substrate corresponding to a fin according to another embodiment of the present disclosure; and

FIG. 7 are sample topography images after salt spray tests of Examples 1˜5 of the present disclosure.

### DESCRIPTION OF EMBODIMENTS

In order to better understand the technical solution of the present disclosure, the embodiments of the present disclosure will be described in detail below with reference to the drawings.

It should be clear that the described embodiments are only part of the embodiments of the present disclosure, but not all of the embodiments. Based on the embodiments of the present disclosure, all other embodiments obtained by those skilled in the art without inventiveness works fall within the protection scope of the present disclosure.

The terms used in the embodiments of the present disclosure are only for the purpose of describing specific embodiments, and are not intended to limit the present disclosure. As used in the embodiments and claims of the present disclosure, the terms “a/an”, “said” and “the” in singular form are also intended to include plural form, unless the context clearly represents other meanings.

It should be understand that the term “and/or” used in the present disclosure is only an association relationship to describe associated objects, which represents that there may be three kinds of relationships. For example, A and/or B, which may represents the following three cases: A exists alone, A and B exist at the same time, and B exists alone. In addition, the character “/” of the present disclosure generally represents that previous and following associated objects are in an “or” relationship.

In the related art, the application of microchannel heat exchanger products is gradually expanding, while the promotion progress thereof is relatively slow. The main technical bottlenecks are that each component in the microchannel heat exchanger is made of aluminum/aluminum alloy with a poor corrosion resistance, and thereby the relevant corrosion resistance coating technology is needed to improve the corrosion resistance of the heat exchanger.

There are some technologies for hydrophobizing process to the surface of the heat exchanger. For example, a hydrophobic coating material is coated on the surface of the heat exchanger to form a hydrophobic coating. With the hydrophobic surface of the hydrophobic coating, the contact angle formed between a droplet and a wall of the heat exchanger increases in the early stage of frost formation, the contact area thereof reduces, so that the droplets freeze more slowly, and correspondingly, the formation of initial frost crystals can be delayed. However, most of the hydrophobic coatings used in the related art are modified silicon dioxide-based sol prepared by sol-gel method. The preparation of the silicon dioxide sol-gel coating usually includes two stages: hydrolysis of silane precursor, and cross-link and curing at high temperature. The Si—OH groups in the sol can be condensed with Me-OH of the metal substrate of the heat exchanger to form bonds, or cross-linked with each other to form a network structure of —Si—O—Si—. Therefore, the silicon dioxide sol-gel coating and the metal substrate of the heat exchanger are combined relatively tight and firm. However, the microporous defects in the coating and the pores caused by the low cross-linking degree may provide a path for the corrosive medium to diffuse to the metal substrate. Based on the defect, if the cross-linking degree of the silicon dioxide sol gel is continuously increased for improvement, excessive cross-linking will lead to more microcracks on the surface of the coating, greater brittleness and even crack. The thickness of a single silane film is only tens to hundreds of nanometers. The film so thin that the corrosion protection effect on the metal substrate is limited. Once the film is damaged, the barrier effect of the silane film disappears, and the corrosion medium is prone to penetrate into the surface of the metal substrate to cause metal corrosion, which also limits the practical application of the sol-gel coating.

Based on this, the technical solutions according to the embodiments of the present disclosure provide a heat exchanger and a processing method of the heat exchanger. For the processing method of the heat exchanger, the present disclosure further provides a method for preparing a composite material for forming a coating. The coating of the heat exchanger in the technical solutions according to the embodiments of the present disclosure has relatively excellent corrosion resistance. While ensuring hydrophobicity, frost resistance and corrosion resistance, the coating is green and environmentally friendly. There is no irritating odor and hazardous chemicals in the formulation for preparing the coating, resulting in a better user experience. The specific technical solutions are described below.

In the present disclosure, unless otherwise stated, the percentage, proportion or copies referred are by mass. The term “part by mass” refers to the basic measurement unit of the mass ratio relationship of multiple components. 1 part by mass may represent any unit mass, for example, 1 g, 1.68 g or 5 g, etc.

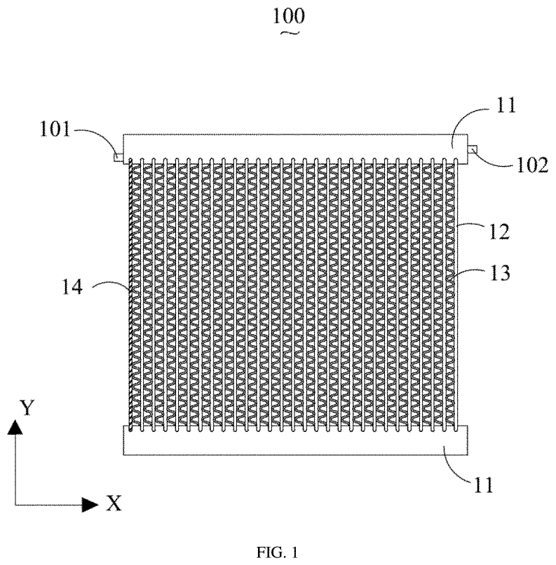

As shown in FIG. 1, the present disclosure provides a heat exchanger 100. The heat exchanger 100 includes a pair of collecting pipes 11, a plurality of heat exchange tubes 12 and a plurality of fins 13. The plurality of heat exchange tubes 12 are all fixed to the collecting pipes 11. The heat exchange tubes 12 are provided with a plurality of channels 122 for refrigerants to flow and each of the plurality of channels 122 is communicated with inner cavities of the collecting pipes 11. At least part of the fins 13 are fixed between two adjacent heat exchange tubes 12. Each of the collecting pipes 11 is provided with a fluid inlet 101 and a fluid outlet 102 communicated with the inner cavity thereof, so as to facilitate the fluid entering the heat exchanger.

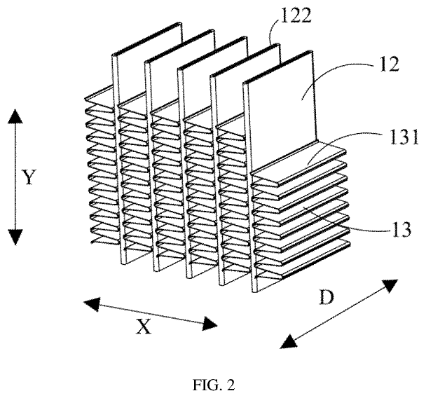

The heat exchange tubes 12 are arranged along the length direction of the collecting pipes 11, and the length direction of the collecting pipes 11 may refer to the X direction in FIG. 1. The heat exchange tubes 12 is a flat tube structure extending longitudinally, the length direction of the heat exchange tubes 12 may refer to the Y direction in FIG. 1, and the width direction of the heat exchange tubes 12 may refer to the D direction in FIG. 2. The dimension in the width direction of the heat exchange tubes 12 is larger than that in the thickness direction of the heat exchange tubes 12, and the thickness direction of the heat exchange tubes 12 substantially coincides with the length direction of the collecting pipes 11. In addition, the width direction of the heat exchange tubes 12 and the length direction of the collecting pipes 11 are not co-directional. In FIG. 2, the width direction (D direction) of the heat exchange tubes 12 is substantially perpendicular to the length direction (X direction) of the collecting pipes 11.

As shown in FIG. 1, the number of the collecting pipes 11 is two, and the opposite ends of the heat exchange tubes 12 in the length direction are inserted into the inner cavities of the two collecting pipes 11, respectively. The type of the heat exchanger is usually referred to as a single row heat exchanger in the industry. In some other embodiments, the number of the collecting pipes 11 may be more than two. Correspondingly, the number of the heat exchange tubes and fins is also set according to the actual product needs.

In some embodiments, as shown in FIG. 2, the fins 13 present a waveform structure along the length direction (Y direction) of the heat exchange tubes 12. The fins 13 include a plurality of fin units 131 arranged along the length direction of the heat exchange tubes 12, and the plurality of fin units 131 are connected to each other along the length direction of the heat exchange tubes 12 in sequence. A wave crest or a wave trough in the waveform structure corresponding to the fins 13 is formed at the junction of two adjacent fin units 131, and the fins 13 are fixed to the heat exchange tubes 12 at the junction of two adjacent fin units 131. During assembly, the collecting pipes 11, the fins 13, the heat exchange tubes 12 and other components can be assembled together in advance. The collecting pipes 11 and the heat exchange tubes 12 are fixed by brazing, and the fins 13 are fixed between two adjacent heat exchange tubes.

The heat exchanger 100 further includes a coating 14. The coating 14 is coated on at least part of an outer surface of at least one of the collecting pipes 11, the heat exchange tubes 12 and the fins 13. In FIG. 1, the coating 14 is relevantly illustrated by the shaded portion on the surface of the leftmost heat exchange tube 12 of the heat exchange tubes 12. The coating 14 of the heat exchanger 100 according to the present disclosure may be a single-layer coating, a double-layer coating, and also a multi-layer coating with more layers. In some embodiments of the present disclosure, a static contact angle between the coating 14 and water is greater than 150°, and a droplet rolling angle of the coating 14 is less than 5°.

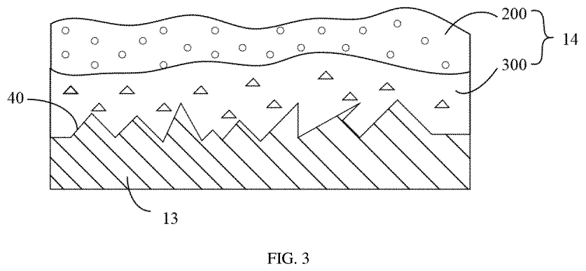

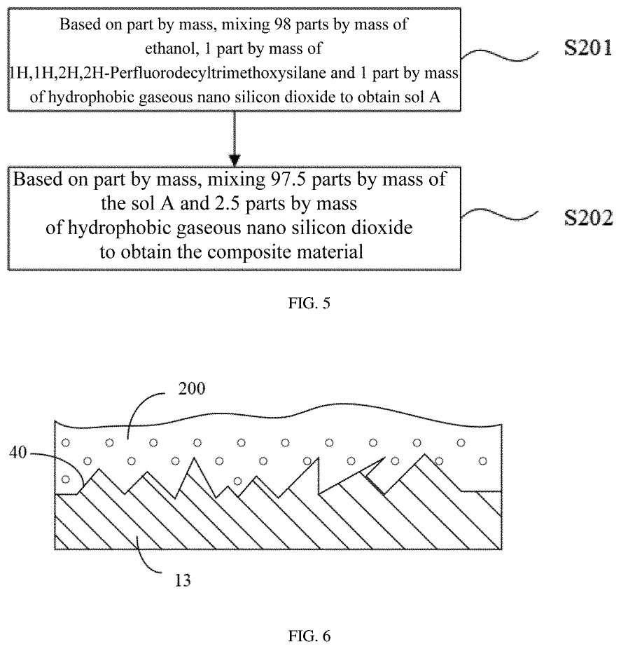

In some embodiments, the material of a metal substrate corresponding to any one of the collecting pipes 11, the fins 13 and the heat exchange tubes 12 includes at least one of aluminum, cooper and stainless steel. In some embodiments, in order to facilitate the adhesion of the coating 14 and improve the connection strength between the metal substrates corresponding to the components of the heat exchanger 100 and the coating, as shown in FIGS. 3 and 5, taking the fins 13 as examples in the above drawings, the outer surface of the metal substrate corresponding to the fins 13 includes an uneven rough surface 40 with a roughness Ra of 0.5 μm˜10 μm. In some embodiments, the roughness Ra of the above rough surface 40 is 1 μm˜3 μm. In some embodiments, the roughness of the above rough surface 40 may be 1 μm, 1.2 μm, 1.4 μm, 1.6 μm, 1.8 μm, 2.0 μm, 2.2 μm, 2.4 μm, 2.6 μm, 2.8 μm, 3 μm, etc., but it is not limited to the listed values, and other values not listed in the numerical range are also applicable.

The rough surface 40 of the metal substrate of each above component can be obtained by sandblasting the heat exchanger 100. Note that the sandblasting process for the heat exchanger 100 in the present disclosure is to perform sandblasting on the basis of being assembled and fixed the various metal components of the heat exchanger. If the metal components are sandblasted in advance, the flux will adhere to the sandblasted rough surface of the corresponding component during the subsequent process of connecting each component by brazing, making it difficult for the coating material to adhere. The durability can be improved when combined with other subsequent coating materials by controlling the roughness of the surface of the metal substrate. Although a greater roughness is favorable to the adhesion of subsequent coatings, if the roughness is too great, for example, greater than 10 μm, the deformation of the metal substrate will be relatively large, and there is also a relatively high requirement for the thickness of the metal substrate, otherwise, the metal substrate is prone to be damaged. If the roughness is too less, the improvement of the durability of the coating is not obvious.

In some embodiments of the present disclosure, at least one functional film is spaced between a first matching coating 200 and at least one surface of the collecting pipes 11, the heat exchange tubes 12 and the fins 13. The at least one functional film may be a corrosion-resistant rare earth conversion coating, or may be other functional coatings.

In an embodiment, as shown in FIG. 3, the coating 14 includes the first matching coating 200 and a second matching coating 300. At least part of the second matching coating 300 is in contact with the surface of the metal substrate corresponding to the heat exchanger 100. At least part of the first matching coating 200 is coated on the surface of the second matching coating 300. The first matching coating 200 includes a hydrophobic material and a filler of nanoparticle type. The weight per unit are of the first matching coating 200 is in a range of 0.1 g/m²˜1 g/m². In FIG. 3, the filler of nanoparticle type are illustrate in a circular structure.

The second matching coating 300 includes a compound containing elements. In FIG. 3, the second matching coating 300 is in contact with the rough surface 40, and at least part of the first matching coating 200 is located at a side of the second matching coating 300 away from the rough surface 40. The first matching coating 200 may be a top coating exposed to the environment.

When preparing the coating 14, the heat exchanger can be subjected to rare earth conversion processing in advance to form a layer of rare earth conversion coating, and then the hydrophobic film surface processing can be performed on the heat exchanger. The hydrophobic first matching coating 200, the second matching coating 300 formed after rare earth conversion processing, and the sandblasted heat exchanger 100 are tightly combined. The second matching coating 300 formed after rare earth conversion processing can further improve the corrosion resistance of the entire coating 14 and block the cathodic reduction reaction when a local pitting occurs, thereby improving the corrosion resistance of the heat exchanger. Moreover, due to the good corrosion resistance of the second matching coating 300 to the surface of the heat exchanger, the surface of the metal substrate of the heat exchanger is not prone to generate more locally raised metal corrosion oxides. Correspondingly, the destructive effect on the first matching coating 200 is small, and the second matching coating 300 in turn is conducive to maintaining the durability of the first matching coating 200. The first matching coating 200 can utilize the good hydrophobicity thereof to effectively reduce the adhesion and enrichment of the corrosion solution, avoid the deficiencies that the existing chromate passive film is both brittle and hard, and reduce the penetration of the corrosion medium into the metal substrate, and thereby further improves the corrosion resistance of the heat exchanger and effectively prolongs the frosting duration on the surface of the heat exchanger. Therefore, through the cooperation of the first matching coating 200 and the second matching coating 300, not only the corrosion resistance of the heat exchanger is improved, which is conducive to prolonging the service life of the heat exchanger, but also the hydrophobic property is generated on the surface of the heat exchanger, which can delay the frost formation. Furthermore, when the heat exchanger is applied to an air-conditioning system or a heat pump system, it is conducive to prolonging the service life and improve the heat exchange efficiency of the heat exchanger.

The specific types of the compound containing rare earth elements in the second matching coating 300 may be various in case of meeting the needs of improving the corrosion resistance of the heat exchanger. In some embodiments, the rare earth elements of the compound containing rare earth elements include lanthanide rare earth elements. The lanthanide rare earth elements include at least one of lanthanum, cerium, praseodymium, neodymium, promethium, samarium and europium. For example, the compound containing rare earth elements may be a lanthanum-containing compound, a cerium-containing compound, a praseodymium-containing compound, a neodymium-containing compound, a promethium-containing compound, a samarium-containing compound, a europium-containing compound, or a mixture of any two or more of the above compounds in any ratio.

In some embodiments, the above rare earth elements may be cerium, and the compound containing rare earth elements may be the cerium-containing compound. In some embodiments, the compound containing rare earth elements includes cerium oxides (such as ceria, i.e., CeO₂) and cerium hydroxides (such as cerium hydroxide, i.e., Ce(OH)₄). Based on the considerations of wide sources, easy availability or cost, the cerium-containing compound is selected as the compound containing rare earth elements, and the cerium-containing compound is in a state in which CeO₂ and cerium hydroxide Ce(OH)₄ coexist. In this way, the chemical properties are stable, which is conducive to improving the pitting corrosion resistance effect and the corrosion resistance of the heat exchanger.

In some embodiments, the weight per unit area of the second matching coating 300 is controlled at 0.75 g/m^{2˜1.2} g/m². In some embodiments, the weight per unit area of the first matching coating 200 is in a range of 0.1 g/m²˜1 g/m². Appropriate film thickness of the second matching coating 300 (rare earth conversion coating) and the first matching coating 200 (hydrophobic coating) can effectively improve the corrosion resistance of the heat exchanger and delay the frost formation, without causing too much negative impact on the heat exchange efficiency of the heat exchanger.

In some embodiments of the present disclosure, the hydrophobic material corresponding to the first matching coating 200 includes an organosilane-based modified material with low surface energy or a sol gel of silane system. The filler of nanoparticle type may be hydrophobic nano silicon dioxide.

When the above two are coordinated, first of all, since the organosilane-based modified material with low surface energy and the sol gel of silane system are both the silicon dioxide three-dimensional network structures formed by the cross-linking of silane materials, the nano silicon dioxide filler can participate in the polycondensation film-forming process after being added, thus increasing the compactness of the entire coating structure, and the compatibility of silane materials and hydrophobic nano silicon dioxide as the filler is good. Secondly, the particles of the nano silicon dioxide as the filler can be filled into the silicon dioxide network, making the first matching coating more compact, improving its hardness and wear resistance, extending the path for the corrosive medium to reach the surface of the substrate, and improving the barrier performance. Finally, the nano silicon dioxide as the filler can inhibit the cathodic reaction of metal corrosion to some extent after being added, and can also improve the corrosion resistance of the entire coating to some extent.

For example, the sol-gel material of silane system is used as hydrophobic material, which is usually obtained by modifying silicon dioxide particles with silane precursors. However, silane precursors are prone to produce gas with pungent odor such as ammonia and acid-washing corrosive solution in the reaction system, which has the risk of damage to manufacturing personnel. In some embodiments of the present disclosure, the organosilane-based modified material with low surface energy is selected as the hydrophobic material.

The organosilane-based modified material with low surface energy according to the embodiments of the present disclosure includes one or more of 1H,1H,2H,2H-Perfluorodecyltriethoxysilane, 1H,1H,2H,2H-Perfluorodecyltrimethoxysilane, 1H,1H,2H,2H-Perfluorooctyltriethoxysilane, octadecyltrimethoxysilane and hexadecyltrimethoxysilane. The nano-silicon dioxide-based hydrophobic filler can be cooperated with the organosilane-based modified material with low surface energy to form a dense network structure. Both the modified material with low surface energy and the hydrophobic filler are hydrophobic, and combination of the two can further control the static contact angle between the coating 14 and water to be greater than 150°, which can be called a superhydrophobic state. The above organosilane-based modified material with low surface energy is not prone to produce pungent odor and harmful substances during the heat exchanger processing, so the risks in the production process can be reduced.

By adding hydrophobic particles of nanoparticle type, the thickness and compactness of the first matching coating can be increased, the mechanical properties of the first matching coating can be improved, the barrier performance of the first matching coating to the corrosive medium can be improved, and the duration for the corrosive medium to reach the metal substrate can be prolonged. However, it should be noted that the addition amount of the particles of nano silicon dioxide as the filler is not the higher the better, but has an optimal addition range. If the addition amount is too small, the compactness and corrosion resistance of the first matching coating cannot reach the optimal state. If the addition amount is too large, a porous film will be formed, which will reduce the corrosion resistance of the film. By adding a reasonable range of the filler of nanoparticle type, the weight per unit area of the first matching coating 200 can be finally controlled in a range of 0.1 g/m²˜1 g/m². Therefore, the heat exchanger 100 can finally achieve better corrosion resistance.

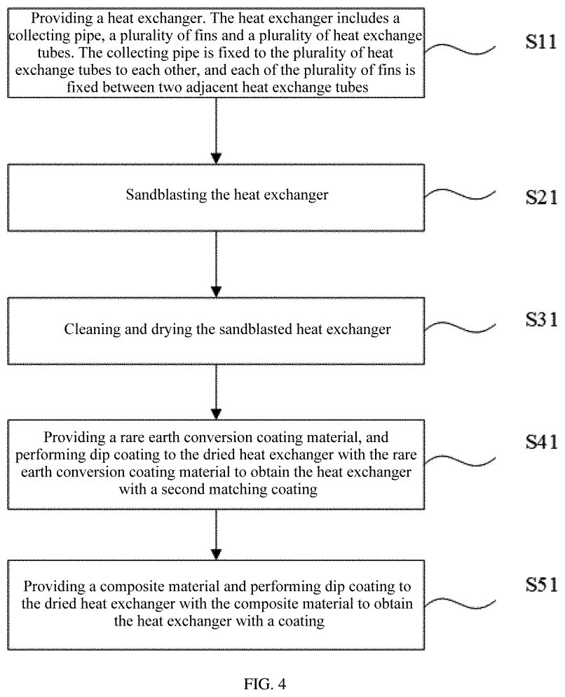

Referring to FIG. 4 in combination with FIG. 3, the processing method of the heat exchanger according to the present disclosure includes steps S11 to S51:

Step S11, providing a heat exchanger. The heat exchanger includes a collecting pipe, a plurality of fins and a plurality of heat exchange tubes. The collecting pipe and the plurality of heat exchange tubes are fixed to each other, and each of the plurality of fins is fixed between two adjacent heat exchange tubes.

Step S21, sandblasting the heat exchanger. The sandblasted heat exchanger satisfies that an uneven rough surface is formed on at least part of the outer surface of the metal substrate corresponding to at least one of the collecting pipe, the fins and the heat exchange tubes.

Step S31, cleaning and drying the sandblasted heat exchanger.

The collecting pipe, the fins and the heat exchange tubes may be welded by brazing. That is, these components are welded into an entirety by brazing. The brazing process is favorable to achieving the sealing of the junction of the above components. However, in the brazing process, brazing flux will be left on the outer surface of the metal substrate of the collecting pipe, the fins and the heat exchange tubes. Moreover, the brazing flux as such is limited by the material properties. The brazing flux is an inorganic material with poor adhesion and is difficult to be combined with the coating material. In practical application, the brazing flux as such is prone to fall off, so that it is difficult for the coating at the position where the brazing flux remains to maintain for a long time. In addition, the metal substrate of each component of the heat exchanger is exposed to the air for a long time. Accordingly, an oxide layer will be formed, which is also unfavorable to being combined with some types of coating materials. Therefore, the surface of the heat exchanger needs to be treated before coating to remove residual brazing flux, oxide, oil stain and other contaminants on the surface, and to contrast a certain rough surface structure for coating adhesion.

In step S21, the step of sandblasting the heat exchanger further includes the following steps: sandblasting the surface of the heat exchanger 1˜3 times by abrasives with an abrasive particle size between 100 meshes and 280 meshes. The abrasives are gravels made of corundum material. In some embodiments, the abrasive particle size is 120˜180 meshes, such as 150 meshes. When sandblasting the heat exchanger, the number of the times of sandblasting for the fins is less than or equal to 3, for the reason is that the fins are relatively thin, and excessive sandblasting may deform or damage the fins. Therefore, the fins can be sandblasted only once during the sandblasting.

The advantages of the sandblasting in the step S21 include: in the first aspect, a large amount of the residual brazing flux, oxide layer, oil stain, and the like remained on the surface of the metal substrate can be removed to obtain a relatively clean surface of the metal substrate. In the second aspect, the sandblasting and polishing of the abrasive is conducive to forming a better micro-rough surface structure on the surface of the metal substrate, and thereby increases the subsequent bonding force with other coating materials and facilitates leveling and decoration of the coating material. In the third aspect, cutting and impact produced by the sandblasting strengthen the mechanical properties of the surface of the metal substrate and improve the fatigue resistance of the metal substrate. In the fourth aspect, the sandblasting can remove irregular structures such as burrs at the surface of the metal substrate, and create small sounded corners on the surface of the metal substrate, especially on the junction where the various components are connected, so that the surface of the metal substrate is more flat and beautiful and is favorable to subsequent processing. The surface structure and form of the metal substrate has changed after sandblasting, and the metal grains are more elaborated and denser. More hydroxyl groups are formed on the surface of the metal substrate after sandblasting. During the process of connecting with the coating, the coating and the metal substrate can be connected by covalent bonds through dehydration condensation between the hydroxyl groups of the hydrophilic coating and the hydroxyl groups of the metal substrate. The connection mode of the covalent bonds is relatively stable, which is conducive to improving the durability of the connection between the metal substrate and the coating.

In other embodiments, the surface of the heat exchanger can also be constructed with a certain roughness through chemical processing such as acid washing or alkali washing, and the excess adhesion on the surface of the metal substrate can be removed by chemical reaction of a solvent such as acid and alkali as cleaning agent with metal oxides, brazing fluxes, etc. However, the cost of the method is high, the process is relatively complicated, and there are certain risks in the cleaning process.

In step S31, the step of cleaning and drying the sandblasted heat exchanger includes the following steps: ultrasonically cleaning the sandblasted heat exchanger with at least one of deionized water, ethanol, or absolute ethanol. The duration of the ultrasonic cleaning is 5 min˜10 min, and the ultrasonic frequency of the ultrasonic cleaning is 80 Hz˜100 Hz. Then, drying the heat exchanger by fan drying, natural drying or baking drying.

Step S41, providing a rare earth conversion coating material, and performing dip coating to the dried heat exchanger with the rare earth conversion coating material to obtain the heat exchanger with the second matching coating.

Further, step S41 further includes two substeps. The first substep is to prepare the rare earth conversion coating material. The method for preparing the rare earth conversion coating material may include: based on part by mass, dissolving 1˜3 parts by mass of the rare earth raw material in 92.5˜97.5 parts by mass of deionized water, and mixing to obtain an intermediate liquid; heating the intermediate liquid to 45° C.˜55° C., adding 1.5˜4.5 parts by mass of an oxidant to the system, and continuously mixing to obtain the rare earth conversion coating material.

The above rare earth raw material may be raw material that can provide rare earth elements, such as a raw material that can provide cerium (Ce). In some embodiments, the rare earth raw material includes, but are not limited to, one or a combination of at least two of cerium nitrate hexahydrate, anhydrous cerium nitrate, cerium chloride as well as the polyhydrate thereof, cerium sulfate as well as the polyhydrate thereof, and cerium acetate as well as the polyhydrate thereof. The above cerium chloride as well as the polyhydrate thereof are anhydrous cerium chloride and the polyhydrate of cerium chloride such as cerium chloride heptahydrate or cerium chloride octahydrate, etc. Similarly, the above cerium sulfate as well as the polyhydrate thereof are anhydrous cerium sulfate and the polyhydrate of cerium sulfate such as cerium sulfate tetrahydrate; the cerium acetate as well as the polyhydrate thereof are anhydrous cerium acetate and the polyhydrate of cerium acetate such as cerium acetate trihydrate or cerium acetate tetrahydrate, etc.

In some embodiments, the oxidant includes, but is not limited to, at least one of hydrogen peroxide, sodium perchlorate, and tert-Butyl hydroperoxide. For example, the oxidant may be an aqueous hydrogen peroxide solution (the mass concentration of hydrogen peroxide is about 27.5 wt. %˜30 wt. %). Alternatively, the oxidant may be sodium perchlorate, or the oxidant may be an aqueous solution of tert-Butyl hydroperoxide or a n-Butyl alcohol of tert-Butyl hydroperoxide (the mass concentration of tert-Butyl hydroperoxide is not less than 60 wt. %).

The second substep is to prepare the second matching coating on the surface of the heat exchanger. The step of preparing the second matching coating may include: immersing the whole heat exchanger into the rare earth conversion coating material by dip coating, keeping at 30° C.˜55° C. for 30 min˜50 min, and taking out and drying the heat exchanger to obtain the second matching coating including the compound containing rare earth elements at the outer surfaces of the collecting pipe, the fins and the heat exchange tubes.

Considering the convenience of implementation, in the present disclosure the method of dip coating is adopted to immerse the whole heat exchanger into the rare earth conversion coating material. However, in other embodiments of the present disclosure, the way to coat the rare earth conversion coating material on the surface of the heat exchanger after sandblasting pretreatment includes, but is not limited to, at least one of dip coating, spray coating, brush coating, flow coating or roller coating. The equations involved in the oxidation reaction of the rare earth conversion coating material on the aluminum surface of the heat exchanger can be as follows:

Aluminum surface reaction: anode (oxidation reaction): Al→Al³⁺+3e

Cathode (reduction reaction): O₂+2H₂O+4e→4OH⁻

H₂O₂+2e→2OH⁻

Ce³⁺+OH⁻+½H₂O₂→Ce(OH)₂²⁺

Ce(OH)₂²⁺±2OH⁻→Ce(OH)₄

Ce(OH)₄→CeO₂+2H₂O

It can be seen that the second matching coating contains a mixture in which Ce(OH)₄ and CeO₂ coexist. Thus, the chemical property is stable, which is conducive to improving the pitting corrosion resistance effect and the corrosion resistance of the heat exchanger.

Step S51, providing a composite material, and performing dip coating on the heat exchanger with the second matching coating with the composite material to obtain the heat exchanger with both the first matching coating and the second matching coating.

Note that after the composite material is coated on at least part of the surface of the heat exchanger with the second matching coating, the whole structure above needs to be cured at a high temperature. During the process of high temperature curing, the aqueous solvent in the composite material will volatilize with the temperature, while the material with low surface energy such as (heptadecafluoro-1,1,2,2-tetradecyl)trimethoxysilane or (heptadecafluoro-1,1,2,2-tetrahydrodecyl) trimethoxysilane will form a film on the aluminum surface of the heat exchanger. Finally, after the curing is completed, the heat exchanger product with the first matching coating and the second matching coating will be obtained. In the present disclosure, the duration for dip coating the heat exchanger with the second matching coating by using the composite material is greater than or equal to 30 s, and further optionally 2˜3 min. The number of times of dip coating is 1˜5, and further optionally 1 time. After the dip coating is completed, the duration of the high temperature curing is 5 min˜30 min. The curing temperature is 100° C.˜130° C., and further optionally 120° C.

In some embodiments of the present disclosure, step S51 further includes a substep, of preparing the composite material. The step of preparing the composite material includes:

Based on part by mass, mixing 95˜99 parts by mass of the hydrophobic material and 1˜5 parts by mass of the filler of nanoparticle type to obtain the composite material. The filler is added to the system by at least one time of addition.

In the above preparation step, the solvent includes one or more of ethanol, methanol and isopropanol. The solvent may be 90 parts by mass, 92 parts by mass, 94 parts by mass, 96 parts by mass, 98 parts by mass, 98.5 parts by mass, 99 parts by mass and 99.5 parts by mass, etc., but it is not limited to the listed values, and other values not listed within the numerical range are also applicable. The organosilane-based modified material with low surface energy may be 0.5 part by mass, 1 part by mass, 3 parts by mass, 5 parts by mass, 7 parts by mass, 8.5 parts by mass, 9 parts by mass and 10 parts by mass, etc., but it is not limited to the listed values, and other values not listed in the numerical range are also applicable. Further, the method for preparing the hydrophobic material may include: based on part by mass, mixing 90˜99.5 parts by mass of the solvent and 0.5˜10 parts by mass of organosilane-based modified material with low surface energy to obtain the hydrophobic material.

The filler of nanoparticle type can be added to the system by one, two or more times of addition. As shown in FIG. 5, the method that the filler is added twice during the process of preparing the composite material is illustrated as follows:

Step S201, based on part by mass, mixing 98 parts by mass of ethanol, 1 part by mass of (heptadecafluoro-1,1,2,2-tetrahydrodecyl)trimethoxysilane and 1 part by mass of hydrophobic gaseous nano silicon dioxide (added for the first time) to obtain sol A.

Step S202, based on part by mass, mixing 97.5 parts by mass of the above-mentioned sol A and 2.5 parts by mass of hydrophobic gaseous nano silicon dioxide (added for the second time) to obtain the composite material.

The total amount of hydrophobic gaseous nano silicon dioxide added can account for 1˜5 parts by mass of the total parts by mass of the composite material. For example, the total amount of hydrophobic gaseous nano silicon dioxide added may be 1 part by mass, 1.5 parts by mass, 2 parts by mass, 2.5 parts by mass, 3 parts by mass, 4 parts by mass and 5 parts by mass, etc., but it is not limited to the listed values, and other values not listed in the numerical range are also applicable. By adding the filler into the system multiple times, the filler can be mixed more uniformly.

As shown in FIG. 6, in some other embodiments of the present disclosure, the coating 14 includes the first matching coating 200 which is in direct contact with at least one of the collecting pipe 11, the heat exchange tubes 12 and the fins 13. In FIG. 6, the first matching coating 200 of the coating 14 is directly coated on the rough surface 40.

Namely, in the embodiment shown in FIG. 6, the heat exchanger 100 does not include the second matching coating 300. Correspondingly, it is unnecessary to perform said coating the rare earth conversion coating material on the surface of the heat exchanger. For the structure of the heat exchanger shown in FIG. 6, the method for sandblasting the heat exchanger is the same as that in the embodiment corresponding to FIG. 4, the method for preparing the composite material and the method for performing dip coating on the heat exchanger with the composite material are also described in detail in the previous embodiments, and will not be repeated here.

In other embodiments provided by the present disclosure, the composite material of the present disclosure can also be applied to non-heat exchanger products, such as heat pumps and water heaters. In addition, the composite material provided by the embodiments of the present disclosure can be applied to other products that need to improve hydrophobic performance and corrosion resistance.

To facilitate the understanding of the present disclosure, multiple sets of experimental verification have been carried out. The present disclosure will be further described below with reference to specific examples and comparative examples. In addition, in order to facilitate the performance test, an aluminum plate is used instead of the heat exchanger for the test. That is, the aluminum plate used here is made of the same material as the heat exchanger is, and the relevant coating material is coated on the aluminum plate to form a coating for the test.

### Example 1

1. Preparing Coating Material

(a) Preparing rare earth conversion coating material includes: based on part by mass, weighing 1 part by mass of cerium nitrate hexahydrate, adding 95.1 parts by mass of deionized water, mechanically stirring until the solid is completely dissolved to obtain a colorless and transparent solution, heating the solution to 50° C. with a water bath, then adding 2.4 parts by mass of n-butanol solution of tert-Butyl hydroperoxide (content ≥70%), continuously stirring and heating to 50° C. to obtain the rare earth conversion solution.

(b) Preparing a composite material: based on part by mass, ultrasonically mixing 98 parts by mass of ethanol, 1 part by mass of (heptadecafluoro-1,1,2,2-tetrahydrodecyl)trimethoxysilane and 1 part by mass of hydrophobic gaseous silicon dioxide for 15 min, and mechanically stirring for 2 h to obtain the composite material.

2. Processing a Plate

(c) Preprocessing a plate: sandblasting the plate by white corundum with 120 meshes. The angle between the spray gun and the position to be coated is about 45°. The distance between the spray gun and the position to be coated is 50 mm. The plate is sandblasted once. Then spray cleaning the plate with absolute ethanol and drying the plate with absolute ethanol at 40° C. for standby.

(d) Immersing the plate treated in step (c) into the rare earth conversion coating material prepared in step (a). After standing at 50° C. for 40 min, taking the plate out and blow drying the plate with cold air or drying naturally to obtain a plate with the second matching coating.

(e) Immersing the plate with the second matching coating obtained in step (d) into the composite material prepared in step (b). After performing dip coating once with a duration of dip coating of 2 min, putting the plate in the oven and curing the plate at 120° C. for 20 min to obtain the plate with the first matching coating and the second matching coating.

### Example 2

Example 2 differs from Example 1 in the proportion of hydrophobic gaseous silicon dioxide in step (b).

In Example 2, said preparing a composite material in step (b) includes: based on part by mass, ultrasonically mixing 97.5 parts by mass of ethanol, 1 part by mass of (heptadecafluoro-1,1,2,2-tetrahydrodecyl)trimethoxysilane and 2.5 parts by mass of hydrophobic gaseous silicon dioxide for 15 min, and mechanically stirring for 2 h to obtain the composite material.

The rest are the same as those in Example 1.

### Example 3

Example 3 differs from Example 1 in the proportion of hydrophobic gaseous silicon dioxide in step (b).

In Example 3, said preparing the composite material in step (b) includes: based on part by mass, ultrasonically mixing 97 parts by mass of ethanol, 1 part by mass of (heptadecafluoro-1,1,2,2-tetrahydrodecyl)trimethoxysilane and 3 parts by mass of hydrophobic gaseous silicon dioxide for 15 min, and mechanically stirring for 2 h to obtain the composite material.

The rest are the same as those in Example 1.

### Example 4

Example 4 differs from Example 1 in the proportion and the adding method of hydrophobic gaseous silicon dioxide in step (b).

In Example 4, said preparing the composite material in step (b) includes:

Based on part by mass, ultrasonically mixing 98 parts by mass of ethanol, 1 part by mass of (heptadecafluoro-1,1,2,2-tetrahydrodecyl)trimethoxysilane and 1 part by mass of hydrophobic gaseous silicon dioxide for 15 min, and mechanically stirring for 2 h to obtain the sol A.

Based on part by mass, ultrasonically mixing 97.5 parts by mass of the sol A and 2.5 parts by mass of hydrophobic gaseous silicon dioxide for 15 min, and mechanically stirring for 30 min to obtain the composite material.

The rest are the same as those in Example 1.

### Example 5

Example 5 differs from Example 1 in the proportion and the adding method of hydrophobic gaseous silicon dioxide in step (b).

In Example 5, said preparing the composite material in step (b) includes:

Based on part by mass, ultrasonically mixing 98 parts by mass of ethanol, 1 part by mass of (heptadecafluoro-1,1,2,2-tetrahydrodecyl)trimethoxysilane and 1 part by mass of hydrophobic gaseous silicon dioxide for 15 min, and mechanically stirring for 2 h to obtain the sol A.

Based on part by mass, ultrasonically mixing 97 parts by mass of the sol A and 3 parts by mass of hydrophobic gaseous silicon dioxide for 15 min, and mechanically stirring for 30 min to obtain the composite material.

The rest are the same as those in Example 1.

### Comparative Example 1

Comparative Example 1 differs from Example 1 in that no rare earth conversion coating and hydrophobic coating are provided in the plate in Comparative Example 1.

### Comparative Example 2

Comparative Example 2 differs from Example 1 in said preparing the composite material in step (b): based on part by mass, mixing 28 parts by mass of hexamethyldisilazane (HMDS), 71 parts by mass of ethanol and 1 part by mass of hydrophilic silicon dioxide, then mechanically stirring at a stirring speed of 250 rpm and performing reaction in a water bath at 35° C. for 30 min to obtain the composite material.

Performance Test

1. Hydrophobic Performance Test (Contact Angle Test)

The test instrument used is a contact angle measurement which adopts the optical imaging principle. The contact angle of the sample is measured by adopting the image contour analysis method. The contact angle refers to the angle formed when the liquid phase is sandwiched between the two tangents of the gas-liquid interface and the solid-liquid interface. The angle is located at the three-phase (solid-liquid-gas) junction on the solid surface which is generated after a drop of liquid is dropped on a solid horizontal plane.

During the test, turning on the contact angle measurement and the computer which is connected to the contact angle measurement, and opening the testing software.

Putting the sample on a horizontal table, and adjusting the amount of droplet with a microliter syringe. The volume of droplet is generally about 1 μL. Droplet is formed on the needle. Rotating the knob to move the table up, so that the surface of the sample is in contact with the droplet, and then moving the table down, so that the droplet can be left on the sample.

Obtaining the contact angle of the area by testing and data analysis through testing software. Taking 5 different points on the samples in each Example and Comparative Example to test and obtaining the average value, and then recording the average value as the contact angle of the samples in the Example and the Comparative Example. The test results are shown in Table 1.

TABLE 1

| | Static contact | Environmental protection |
|---|---|---|
| Item | angle | degree of processing |
| Example 1 | >150° | No odor during processing |
| Example 2 | >150° | No odor during processing |
| Example 3 | >150° | No odor during processing |
| Example 4 | >150° | No odor during processing |
| Example 5 | >150° | No odor during processing |
| Comparative | 90° | No odor during processing |
| Example 1 | | |
| Comparative | >150° | Pungent odor |
| Example 2 | | |

In combination with Table 1, the test results of the above contact angles show that the initial contact angles of the sample surfaces in Example 1 to Example 5 are all greater than 150°, presenting a superhydrophobic state, which indicates that the hydrophobic performance of the coating formed on the plate surface in the embodiments of the present disclosure is relatively excellent and conducive to promoting the discharge of condensed water in confined space. Although the initial contact angle in Comparative Example 2 are also greater than 150°, during the processing in Comparative Example 2, hexamethyldisilazane (HMDS) in the reaction system will produce pungent odors, which are not friendly to the manufacturing personnel.

2. Corrosion Resistance Test (Salt Spray Test)

Performing salt spray test on the plate samples prepared in Examples 1˜5 and Comparative Example 1. Salt spray test refers to test standard ASTM G85 for acid salt spray test. Putting each sample into the salt spray box, and taking it out at regular intervals to observe the corrosion points on the surface. After the acid salt spray test, taking out each sample, observing the surface corrosion of each sample and recording the time when the corrosion points appears.

TABLE 2

| Item | Salt spray test results | Salt spray test time |
|---|---|---|
| Example 1 | A few corrosion points on the surface | 72 h |
| Example 2 | A few corrosion points on the surface | 72 h |
| Example 3 | A few corrosion points on the surface | 96 h |
| Example 4 | Basically no corrosion point on the | 96 h |
| | surface | |
| Example 5 | A few corrosion points on the surface | 96 h |
| Comparative | Intensive multi-point corrosion on the | <24 h |
| Example 1 | surface | |

It can be seen from the data in Table 2 that after more than 70 hours' of acid salt spray test, most of the samples in the present disclosure maintain good surface morphology, only slight corrosion points appear on the surface, and the corrosion resistance is excellent. In particular, the surface of the sample in Example 4 is also substantially free of corrosion points after 96 hours. This reflects to some extent that in the preparation of the composite material, the sample with 3.5 parts by mass of hydrophobic gaseous silicon dioxide added to the hydrophobic material results in better corrosion resistance on the composite material.

It should be noted that if the heat exchanger product is used for the corrosion resistance test, the method used may be as follows: after the heat exchanger is coated, filling the inner cavity of the heat exchanger with nitrogen to a pressure of 1 MPa, then sealing the inlet and outlet of the heat exchanger, leaving an adapter to connect the barometer, then putting the heat exchanger in the salt spray box to perform the salt spray test, and observing the change of the pressure value of the barometer. When the pressure drops, a certain part of the surface heat exchanger is corroded and perforated, and the failure of the heat exchanger is recorded at this time. In practice, the corrosion resistance of the heat exchanger can be determined by comparing the duration for the heat exchanger to drop to a certain pressure.

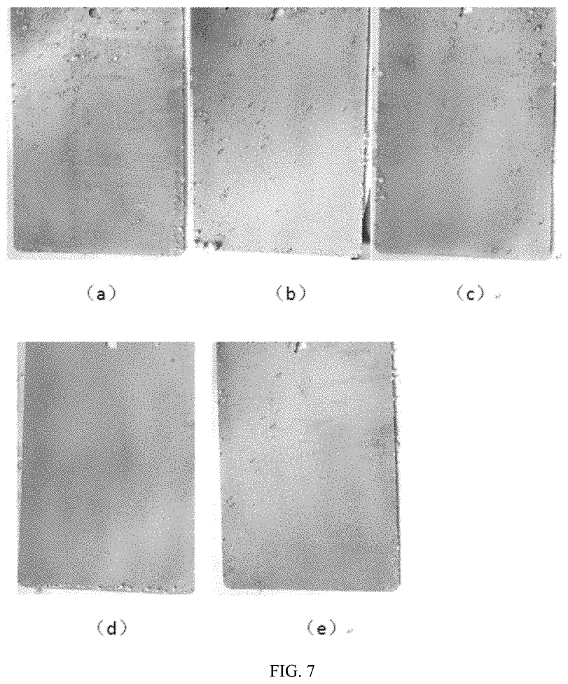

In addition, FIGS. 7(a)-7(e) respectively show the topography images of the samples from Example 1 to Example 5 (the drawings in the first row from left to right are Example 1, Example 2 and Example 3, and the drawings in the second row from left to right are Example 4 and Example 5) of the present disclosure after the salt spray test. It can be seen from FIG. 7 that after the same 96 hours salt spray test, the most corrosion points on the surface appear in the sample of Example 1, and the least, almost no corrosion points on the surface appear the sample of Example 4, which shows that the corrosion resistance of the sample of Example 4 is good.

In the description of the present disclosure, referred terms “one embodiment”, “some embodiments”, “illustrative embodiments”, “example”, “specific example”, or “some examples”, etc., means that the specific features, structures, materials or characteristics described in connection with the embodiments or examples are included in at least one embodiment or example of the present disclosure. In the specification, the schematic representations of the above terms do not necessarily refer to the same embodiment or example. Furthermore, the specific features, structures, materials or characteristics described may be combined in a suitable manner in any one or more embodiments or examples. The location words such as “up”, “down”, “inner” and “outer” described in the embodiments of the present disclosure are described from the angles shown in the drawings, and should not be construed as limitations on the embodiments of the present disclosure.

Although the embodiments of the present disclosure have been shown and described, those skilled in the art can understand that various changes, modifications, substitutions and variants can be made to the embodiments without departing from the principles and purposes of the present disclosure, and the scope of the present disclosure is limited by the claims and their equivalents.

What is claimed is:

1. A heat exchanger, comprising:
a collecting pipe;
a fin;
a plurality of heat exchange tubes; and
a coating,
wherein the plurality of heat exchange tubes are fixed with the collecting pipe, inner cavities of each heat exchange tube communicated with an inner cavity of the collecting pipe, and at least part of the fin is fixed between two adjacent heat exchange tubes,
wherein the coating is coated on at least part of an outer surface of at least one of the collecting pipe, the heat exchange tubes and the fin,
wherein the coating comprises a first matching coating,
the first matching coating is in direct contact with at least one of the collecting pipe, the heat exchange tubes and the fin, or
at least one functional film is placed between the first matching coating and at least one of the collecting pipe, the heat exchange tubes and the fin,
wherein the first matching coating comprises a hydrophobic material and a filler of nanoparticle type, and
wherein a weight per unit area of the first matching coating is in a range of 0.1 g/m²˜1 g/m².

2. The heat exchanger according to claim 1, further comprising a second matching coating in contact with at least one of the collecting pipe, the plurality of heat exchange tubes, and the fin;
wherein at least part of the first matching coating is coated on a surface of the second matching coating, and the second matching coating comprises a compound containing rare earth elements.

3. The heat exchanger according to claim 2, wherein the compound containing rare earth elements comprises cerium oxides and cerium hydroxides.

4. The heat exchanger according to claim 1, wherein the hydrophobic material corresponding to the first matching coating comprises an organosilane-based modified material with low surface energy or a sol gel of silane system, and nanoparticles comprise hydrophobic gaseous silicon dioxide.

5. The heat exchanger according to claim 4, wherein the organosilane-based modified material with low surface energy comprises one or more of 1H,1H,2H,2H-Perfluorodecyltriethoxysilane, 1H,1H,2H,2H-Perfluorodecyltrimethoxysilane, 1H,1H,2H,2H-Perfluorooctyltriethoxysilane, octadecyltrimethoxysilane and hexadecyltrimethoxysilane.

6. The heat exchanger according to claim 5, wherein the collecting pipe, the fin, and the plurality of heat exchange tubes are assembled and fixed as a whole by brazing; the plurality of heat exchange tubes arranged along a length direction of the collecting pipe, a width of each of the heat exchange tubes is greater than a thickness of each of the heat exchange tubes, and a width direction of the plurality of heat exchange tubes and the length direction of the collecting pipe are not co-directional; the fin is corrugated along a length direction of the plurality of heat exchange tubes; the fin comprises fin units arranged along the length direction of the heat exchange tubes, a wave crest or a wave trough in a waveform structure corresponding to the fin is formed at a junction of two adjacent fin units, and the fin is fixed with the heat exchange tubes at the junction of two adjacent fin units; and
wherein the outer surface of at least one of the collecting pipe, the fin, and the plurality of heat exchange tubes comprises a rough surface formed by sandblasting, and a roughness (Ra) of the rough surface satisfies 0.5 μm≤Ra≤10 μm; and the coating is at least partially coated on the rough surface.

7. A processing method of a heat exchanger, comprising following steps:
providing a composite material and a heat exchanger,
wherein the composite material comprises:
a hydrophobic material; and
a filler of nanoparticle type,
wherein the heat exchanger comprises:
a collecting pipe;
a fin; and
heat exchange tubes,
wherein the heat exchange tubes are fixed with the collecting pipe, and inner cavities of the heat exchange tubes are communicated with an inner cavity of the collecting pipe, at least part of the fin is fixed between two adjacent heat exchange tubes, at least part of an outer surface of at least one of the collecting pipe, and the fin and the heat exchange tubes is exposed or coated with at least one further functional film;
coating the composite material on at least part of the outer surface of at least one of the collecting pipe, the fin and the heat exchange tubes, or coating the composite material on the outer surface of the at least one further functional film; and
forming a first matching coating after curing the composite material.

8. The processing method according to claim 7, further comprising preparing the composite material, wherein preparing the composite material comprises:
based on part by mass, mixing 95˜99 parts by mass of the hydrophobic material and 1˜5 parts by mass of the filler of nanoparticle type to obtain the composite material;
wherein the filler of nanoparticle type is added by at least one time of addition.

9. The processing method according to claim 7, further comprising: coating a second matching coating on at least part of the outer surface of at least one of the collecting pipe, the fin and the heat exchange tubes, which comprises:
based on part by mass, dissolving 1˜3 parts by mass of a rare earth raw material in 92.5˜97.5 parts by mass of deionized water, mixing to obtain an intermediate liquid, heating the intermediate liquid to 45° C.˜55° C., adding 1.5˜4.5 parts by mass of an oxidant, and continuously mixing to obtain a rare earth conversion coating material; and
immersing the heat exchanger into the rare earth conversion coating material by dip coating, keeping at 30° C.˜55° C. for 30 min˜50 min, and obtaining, after the heat exchanger is taken out and dried, the second matching coating comprising a compound containing rare earth elements on the outer surface of the collecting pipe, the fin and the heat exchange tubes.

10. The processing method according to claim 9, further comprising:
sandblasting the heat exchanger to form an uneven rough surface on at least part of the outer surface of at least one of the collecting pipe, the fin and the heat exchange tubes; and
cleaning and drying the sandblasted heat exchanger,
wherein the processing method further comprises at least one of a) to g):
a) the hydrophobic material comprises a solvent and an organosilane-based modified material with low surface energy, the solvent comprises one or more of ethanol, methanol and isopropanol, and the organosilane-based modified material with low surface energy comprises one or more of 1H,1H,2H,2H-Perfluorodecyltriethoxysilane, 1H,1H,2H,2H-Perfluorodecyltrimethoxysilane, 1H,1H,2H,2H-Perfluorooctyltriethoxysilane, octadecyltrimethoxysilane and hexadecyltrimethoxysilane;
b) the filler of nanoparticle type comprises hydrophobic gaseous silicon dioxide; wherein the filler is 3.5 parts by mass while preparing the composite material;
c) when sandblasting the heat exchanger, a number of times of sandblasting for the fin is less than or equal to 3;
d) sandblasting the heat exchanger comprises: mixing white corundum abrasives with a particle size of 100˜180 meshes in compressed air, and spraying at an outer surface of the heat exchanger through a spray gun;
e) cleaning and drying the sandblasted heat exchanger comprises: ultrasonically cleaning the sandblasted heat exchanger with at least one of deionized water, ethanol, or absolute ethanol, and then drying the heat exchanger by fan drying, natural drying or baking drying, wherein a duration of the ultrasonic cleaning is 5 min˜10 min, and an ultrasonic frequency of the ultrasonic cleaning is 80 Hz-100 Hz;
f) the composite material is coated on a surface of the second matching coating by dip coating, the dip coating is applied 1 or more times, and a duration of each dip coating is greater than or equal to 30 s; and
g) a curing temperature for curing the composite material is 110° C.˜130° C., and a duration of curing is 5 min˜30 min.

11. A heat exchanger, comprising:
a pair of collecting pipes being spaced from each other, each collecting pipe defining an inner cavity;
a plurality of flat tubes arranged along an axial direction of the pair of collecting pipes, each flat tube comprising two opposite ends retained to a corresponding one of the collecting pipes, respectively; the plurality of flat tubes defining a row of channels for refrigerants to flow, the channels being disposed along a width direction of the plurality of flat tubes; the channels being in fluid communication with the inner cavities of each of the collecting pipes;
a plurality of fins each being sandwiched between two adjacent flat tubes; and
a first matching coating being directly or indirectly contacted with at least one outer surface of one of the pair of collecting pipes, the plurality of flat tubes, or the plurality of fins,
wherein the first matching coating comprises a hydrophobic material and a filler of nanoparticle type.

12. The heat exchanger as claimed in claim 11, wherein a weight per unit area of the first matching coating is in a range of 0.1 g/m^{2˜1} g/m².

13. The heat exchanger as claimed in claim 11, further comprising a functional film located between the first matching coating and at least one outer surface of the pair of collecting pipes, the plurality of flat tubes, or the plurality of fins; the first matching coating being indirectly contacted with at least one outer surface of the pair of collecting pipes, the plurality of flat tubes, or the plurality of fins.

14. The heat exchanger as claimed in claim 13, wherein the functional film is a compound containing rare earth elements comprising cerium oxides and cerium hydroxides.

15. The heat exchanger as claimed in claim 11, further comprising a second matching coating in contact with at least one outer surface of the pair of collecting pipes, the plurality of flat tubes, or the plurality of fins;
wherein at least part of the first matching coating is coated on a surface of the second matching coating, and the second matching coating comprises a compound containing rare earth elements.

16. The heat exchanger as claimed in claim 11, wherein the pair of collecting pipes, the plurality of flat tubes, and the plurality of fins are retained by brazing, the flat tubes are arranged along a length direction of the pair of collecting pipes, a width of each flat tube is greater than a thickness of each flat tube, and a width direction of the plurality of flat tubes is perpendicular to the length direction of the pair of collecting pipes.

17. The heat exchanger as claimed in claim 11, wherein each fin of the plurality of fins is corrugated along a length direction of the plurality of flat tubes, and each fin comprises a wave crest and a wave trough connecting with two side walls of two adjacent flat tubes, respectively.

18. The heat exchanger as claimed in claim 11, wherein the outer surface of at least one of the pair of collecting pipes, the plurality of flat tubes, or the plurality of fins comprises a rough surface formed by sandblasting, and a roughness (Ra) of the rough surface satisfies 0.5 μm≤Ra≤10 μm; and the first matching coating is at least partially coated on the rough surface.

19. The heat exchanger as claimed in claim 11, wherein the hydrophobic material corresponding to the first matching coating comprises an organosilane-based modified material with low surface energy or a sol gel of silane system, and nanoparticles comprise hydrophobic gaseous silicon dioxide.

20. The heat exchanger as claimed in claim 19, wherein the organosilane-based modified material with low surface energy comprises one or more of 1H,1H,2H,2H-Perfluorodecyltriethoxysilane, 1H,1H,2H,2H-Perfluorodecyltrimethoxysilane, 1H,1H,2H,2H-Perfluorooctyltriethoxysilane, octadecyltrimethoxysilane and hexadecyltrimethoxysilane.
